(19) United States
(12) Patent Application Publication
(10) Pub. No.: US 2026/0147839 A1
(43) Pub. Date: May 28, 2026

(54) RETRIEVAL PERFORMANCE WITH DOCUMENT HIERARCHY TREES

(71) Applicant: NVIDIA Corporation, Santa Clara, CA (US)

(72) Inventors: Jiaheng HUANG, Shenzhen (CN); Nian ZHOU, Shenzhen (CN)

(21) Appl. No.: 19/079,309

(22) Filed: Mar. 13, 2025

(30) Foreign Application Priority Data
Nov. 28, 2024 (WO) PCT/CN2024/135162

(51) Int. Cl. G06F 16/93

(52) U.S. Cl. CPC G06F 16/93

(57) ABSTRACT

In various examples, a technique for querying a hierarchical representation of a document includes receiving a hierarchical document tree including one or more parent and child nodes each associated with a portion of a source document and generating, using a machine learning model and based at least on a query prompt and contents of each of the one or more parent and child nodes, a similarity score for each of the one or more parent and child nodes. The technique also includes calculating combined similarity scores associated with each of one or more child nodes based at least on the similarity score associated with the child node and one or more similarity scores associated with one or more nodes having a parent relationship to the child node and generating a query result based at least on the combined similarity scores associated with the one or more child nodes.

### CROSS-REFERENCE TO RELATED APPLICATIONS

This application claims priority to the International Patent Application titled, “CONSTRUCTING A DOCUMENT HIERARCHY TREE USING MACHINE LEARNING MODELS”, filed on Nov. 28, 2024, and having Serial No. PCT/CN2024/135162. The subject matter of this related application is hereby incorporated herein by reference.

### TECHNICAL FIELD

Embodiments of the present disclosure relate generally to data processing and machine learning and, more specifically, to techniques for constructing and querying document hierarchy trees.

### BACKGROUND

Retrieving relevant information from a document based on a search query is a common task in text processing. However, an isolated portion of a document, such as a single paragraph, that exhibits the greatest similarity to a search query may not include the most accurate or most complete information relevant to the query. Specifically, in a document having a hierarchical structure including multiple levels of headings and subheadings, one or more parent headings may contain semantic information relevant to a subordinate or child paragraph. Representing a document as a hierarchical arrangement of headings, subheadings, and paragraphs may improve subsequent search operations that augment the semantic information included in a paragraph with additional semantic information included in parent subheadings or headings.

Existing techniques for generating a hierarchical representation of a source document may include training an end-to-end machine learning model to process the source document and generate the hierarchical representation in a single operation. One drawback of these existing methods is that training the end-to-end machine learning model may require large quantities of generalized training data. Collecting sufficient generalized training data may be expensive, difficult, and time-consuming. Further, the trained end-to-end model may still exhibit poor generalization performance, generating accurate hierarchical representations for some source documents while failing to adequately represent hierarchical relations in other source documents.

Other existing techniques for generating a hierarchical expression of a source document may include processing the source document via a multimodal large language model (LLM) to generate the hierarchical expression of the source document. One drawback of these techniques is that the multimodal LLM may only be operable to process a single image as an input. For a given source document including multiple pages, where each page is stored as a single image, a multimodal LLM may not be able to detect a hierarchical arrangement of headings, subheadings, and paragraphs that span multiple pages within the document.

Existing methods for querying a document having a hierarchical representation may generate a similarity score associated with each individual paragraph in the document. The similarity score may be based on the semantic content of the individual paragraph and one or more search queries. One drawback of these methods is that a similarity score generated for an individual paragraph may ignore relevant semantic content included in one or more parent entities included in the hierarchical representation, such as headings or subheadings associated with the individual paragraph. Existing querying techniques may generate a high similarity score associated with one paragraph based on the semantic content of the individual paragraph, while a different paragraph having a lower individual similarity score may be more contextually relevant to a query if the semantic context of one or more parent entities associated with the paragraph were taken into account.

As such, a need exists for more effective techniques for generating hierarchical representations of source documents, and for searching hierarchical document representations for information relevant to one or more search queries.

### SUMMARY

One embodiment of the present disclosure relates to generating a hierarchical representation of a source document. The techniques described herein include generating, via a first machine learning model, a hierarchical structure associated with a source document such that the hierarchical structure includes one or more headings and one or more paragraphs. The techniques also include identifying, via the first machine learning model, heading text included in the source document and associated with each of the one or more headings and paragraph text included in the source document and associated with each of the one or more paragraphs. The techniques further include generating, via a second machine learning model and based on the identified heading text included in the source document, a formatted listing including the heading text associated with each of the one or more headings, generating a hierarchical document based on the formatted listing and the paragraph text associated with the one or more paragraphs, and performing a query on the source document based on the hierarchical document.

In contrast to conventional techniques that attempt to generate a hierarchical representation in a single step via an end-to-end machine learning model, the disclosed techniques employ a two-step process that first generates, via the LLM, a hierarchical representation including only identified headings and subheadings, and then inserts paragraph content under the appropriate headings and subheadings. This two-step process is suitable for analyzing large multi-page documents, as the LLM is only required to predict the structure of the source document, e.g., headings and subheadings, rather than generating both the structure and the semantic paragraph content of the source document.

Another embodiment of the present disclosure relates to querying a hierarchical representation of a source document. The disclosed techniques described herein include receiving a hierarchical document tree including one or more parent and child nodes, where each of the one or more parent and child nodes is associated with a portion of a source document. The techniques also include generating, via a machine learning model, a similarity score for each of one or more parent and child nodes, based on a query prompt and the contents of the parent or child node. The techniques further include calculating combined similarity scores associated with each of one or more child nodes, based on the similarity score associated with the child node and one or more similarity scores associated with one or more nodes having a parent relationship to the child node, and generating a query result based on the combined similarity scores associated with the one or more child nodes.

In contrast to conventional techniques that return query results based solely on the semantic content included in isolated individual paragraphs, the disclosed techniques also consider the semantic content of one or more parent entities associated with a paragraph and generate a suitable query response based on both the semantic content included in the paragraph and the semantic content included in the one or more parent entities. As such, the disclosed techniques automatically generate a hierarchical representation of a source document and generate relevant results for queries applied to the hierarchical representation.

### BRIEF DESCRIPTION OF THE DRAWINGS

The present systems and methods for generating and querying a hierarchical representation of a source document are described in detail below with reference to the attached drawing figures, wherein:

FIG. 1 is a block diagram of an example computing device suitable for use in implementing some embodiments of the present disclosure;

FIG. 2 is a more detailed illustration of the construction engine of FIG. 1, according to various embodiments;

FIG. 3 illustrates a flow diagram of a method for generating a hierarchical representation of a source document, according to various embodiments;

FIG. 4 is a more detailed illustration of the query engine of FIG. 1, according to various embodiments;

FIG. 5 illustrates a flow diagram of a method for querying a hierarchical representation of a source document, according to various embodiments;

FIG. 6 is a block diagram of an example computing device suitable for use in implementing some embodiments of the present disclosure;

FIG. 7 is a block diagram of an example data center suitable for use in implementing some embodiments of the present disclosure;

FIG. 8A is a block diagram of an example generative language model system suitable for use in implementing at least some embodiments of the present disclosure;

FIG. 8B is a block diagram of an example generative language model that includes a transformer encoder-decoder suitable for use in implementing at least some embodiments of the present disclosure;

FIG. 8C is a block diagram of an example generative language model that includes a decoder-only transformer architecture suitable for use in implementing at least some embodiments of the present disclosure; and

FIG. 9 is an example tree structure associated with a hierarchical document, according to at least some embodiments of the present disclosure.

### DETAILED DESCRIPTION

Systems and methods are disclosed related to generating and querying hierarchical representations of documents. Although the present disclosure may be described with respect to generating and querying hierarchical representations of text-based documents, this is not intended to be limiting. For example, the systems and methods described herein may be used, without limitation, to generate and query hierarchical representations of documents including text, tables, figures, images, designs, models, etc. In addition, although the use of large language models (LLMs) is primarily described, this is not intended to be limiting, and other model types may be used-such as vision language models (VLMs), multi-modal language models (MMLMs), transformer models, generative models, etc.—without departing from the scope of the present disclosure.

As discussed herein, conventional techniques that use a single end-to-end machine learning model may fail to generate accurate hierarchical representations of source documents, especially longer multi-page source documents. Further, conventional document querying techniques may generate query results based on the semantic content of individual paragraphs analyzed in isolation, and may ignore the hierarchical structure of a document, where parent entities, such as headings and subheadings, may contain additional relevant semantic content.

To improve the generating and querying of hierarchical document representations, the disclosed techniques generate an accurate hierarchical representation of a source document via a two-step process, where the techniques first identify headings, subheadings, and paragraphs in a source document and generate a formatted hierarchical representation that includes only the headings and subheadings. In a second step, the disclosed techniques restore items of paragraph content, such as text, figures, or tables, to their respective locations within the hierarchical representation. When querying a generated hierarchical representation, the disclosed techniques generate node similarity scores associated with one or more query terms and the semantic content of multiple nodes included in the hierarchical representation, including nodes associated with headings, subheadings, and paragraphs. For each paragraph node, the techniques calculate a reciprocal rank fusion (RRF) score that includes a weighted combination of the paragraph node similarity score and the node similarity scores for one or more parent nodes associated with the paragraph node, where the parent nodes may represent headings or subheadings. By considering semantic content included in both a paragraph node and associated parent nodes, the disclosed techniques may generate more relevant and useful query results compared to conventional methods.

A construction engine may include a parsing module that converts an input source document into an image format. The parsing module then extracts text characters from the converted source document, along with a document location associated with each of the extracted text characters. The document location may specify a particular page included in the converted source document, as well as coordinates within the particular page associated with the extracted text characters.

The construction engine may include a layout machine learning model (MLM) trained to generate one or more bounding shapes associated with a converted source document. A bounding shape may identify a portion of the converted source document, such as a heading, subheading, or paragraph. For example, a bounding shape may indicate a specific page within the converted source document and coordinates defining two opposing corners of a rectangular region included in the page. The layout MLM may classify each bounding shape as representing a heading, subheading, or paragraph. The construction engine may compare coordinates associated with the one or more bounding shapes with the coordinates of text extracted from the converted source document and associate extracted text with corresponding bounding shapes based on the comparison. In various embodiments, either or both of headings and subheadings may include hierarchical document elements, such as a document title, a section title, a chapter title, an abstract heading, a bullet point, or an item included in an ordered list.

The construction engine may identify extracted text associated with bounding shapes representing headings and subheadings, and generate a large language model (LLM) prompt based on the extracted text. The construction engine may direct the LLM to generate a formatted, hierarchical structure of headings and subheadings based on the LLM prompt. For example, the construction engine may direct the LLM to generate a Javascript object notation (JSON)-formatted hierarchical representation of the source document including headings and subheadings identified in the source document.

The construction engine may insert paragraph text extracted from the source document into the formatted hierarchical representation, based on the categories and locations associated with bounding shapes identified by the layout MLM. The construction engine generates a hierarchical document including identified headings, subheadings, and paragraph content.

The disclosed techniques are further operable to query a generated hierarchical document based on one or more query terms. When performing a query, the disclosed techniques consider not only the semantic content associated with a paragraph included in the hierarchical document, but also the semantic content included in one or more headings and subheadings within the hierarchical document that exhibit a parent relationship to the paragraph.

A query engine receives a hierarchical document generated by the construction engine, and query input including one or more query terms. The query engine generates a tree structure based on the hierarchical documents, where the tree structure includes nodes and edges. Each node included in the tree structure corresponds to a heading, subheading, or paragraph included in the hierarchical document. Each edge included in the tree structure indicates a parent/child relationship between two nodes included in the tree structure. The tree structure includes a root node that has no parent nodes. For example, a root node may be associated with a heading including a title of the hierarchical document. The tree structure also includes one or more paragraph nodes, where a paragraph node does not have any associated child nodes. For example, a paragraph node may represent a paragraph, figure, or table included in the hierarchical document.

The query engine traverses the generated tree structure and generates a semantic vector embedding for each node included in the tree structure, where the vector embedding for a node is based on the semantic content of the heading, subheading, or paragraph associated with the node. The query engine may also generate vector embeddings associated with the one or more query terms included in the query input.

The query engine includes a query machine learning model trained to generate a similarity score based on the vector embeddings associated with a node of the tree structure and the vector embeddings associated with the one or more query terms. The query machine learning model traverses the tree structure and generates a similarity score for each node included in the tree structure.

The query engine generates a reciprocal rank fusion (RRF) score associated with each node in the tree structure that corresponds to a paragraph included in the hierarchical document. The query engine calculates the RRF score based on the similarity score associated with the paragraph node and one or more similarity scores associated with nodes having a parent relationship to the paragraph node. For example, various nodes included in the tree structure and associated with headings and subheadings may all have parent relationships to a particular paragraph node. The query engine generates the RRF score associated with the paragraph node based on a weighted combination of the similarity scores associated with the paragraph node and the one or more parent nodes.

After generating RRF scores for each paragraph node included in the tree structure, the query engine ranks the paragraph nodes based on the paragraph nodes' associated RRF scores. The query engine then generates one or more query results. The query results may include the contents of one or more paragraphs included in the hierarchical document and having the highest associated RRF scores. By generating query results based not only on the semantic content of individual paragraphs included in a document, but also on the semantic content of one or more headings, or subheadings included in the document, the disclosed techniques may generate query results that are more useful and relevant to the one or more query terms compared to conventional techniques.

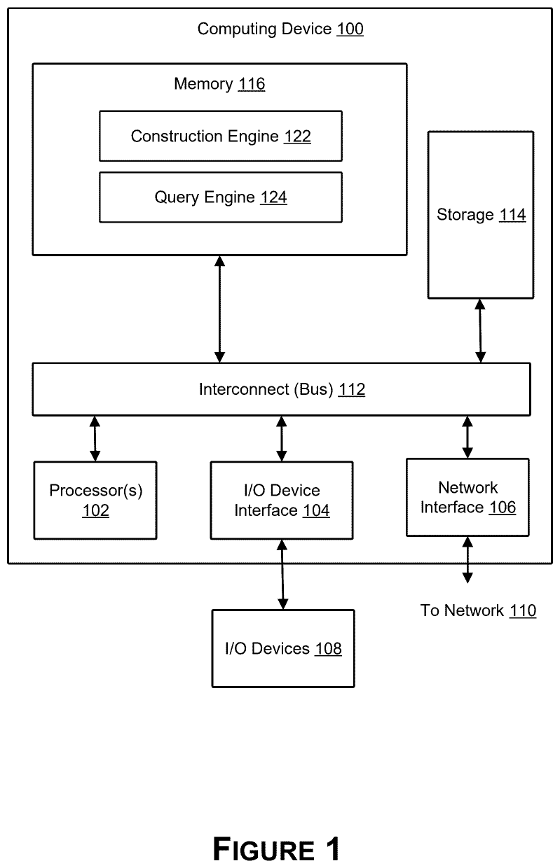

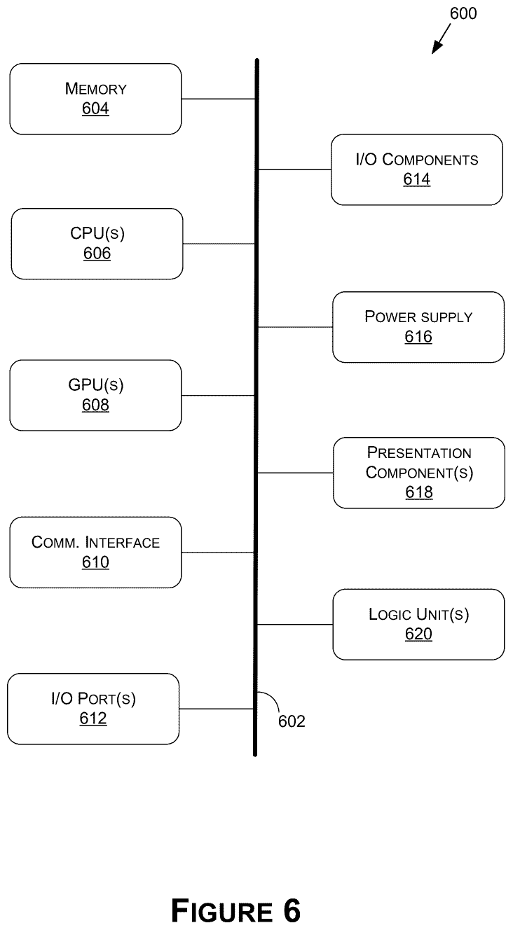

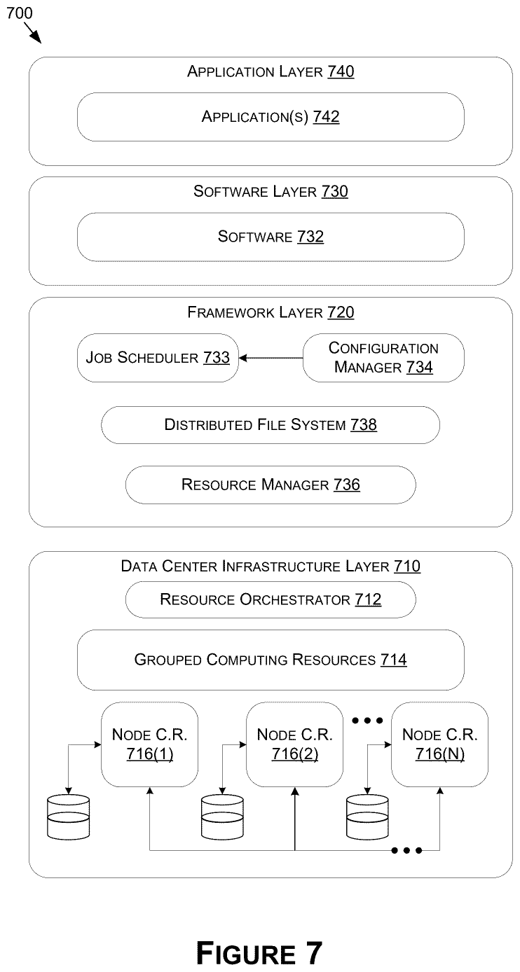

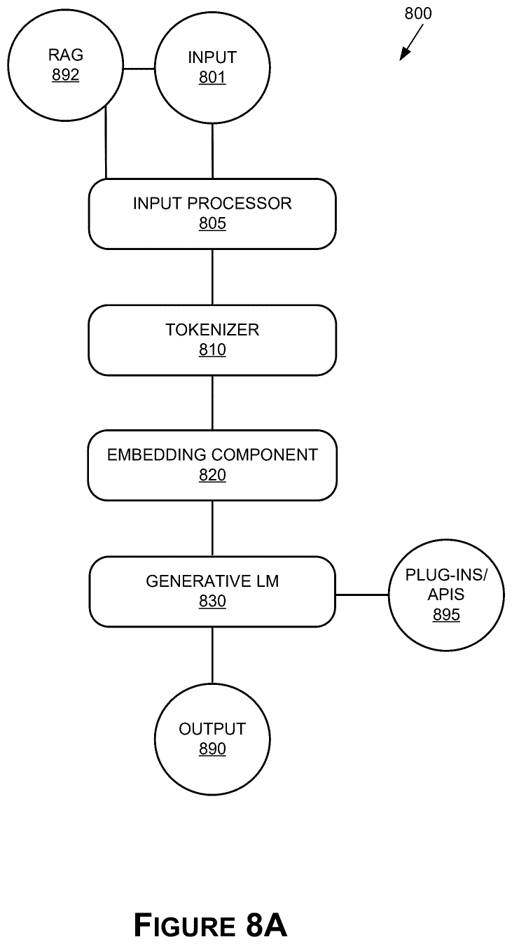

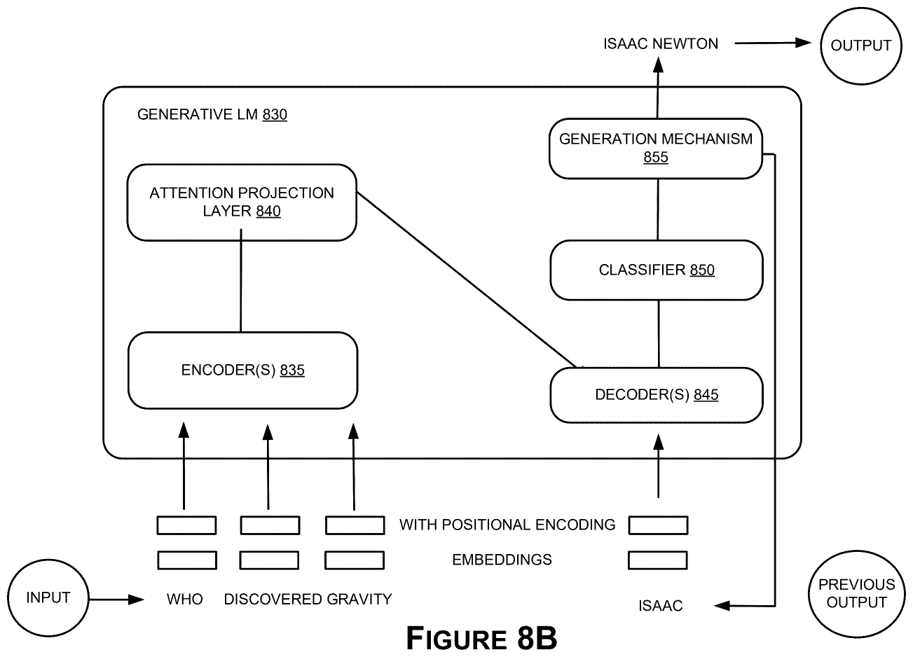

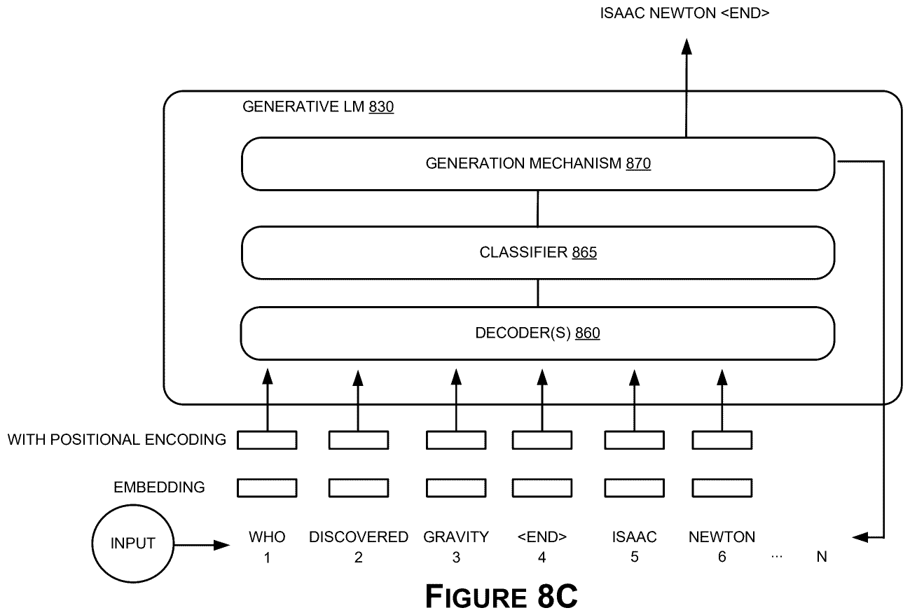

FIG. 1 is a block diagram of an example computing device suitable for use in implementing some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 600 of FIG. 6, example data center 700 of FIG. 7, and/or the machine learning models of FIGS. 8A-8C.

In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a construction engine 122 and a query engine 124 that reside in a memory 116.

It is noted that the computing device described herein is illustrative and that any other technically feasible configurations fall within the scope of the present disclosure. For example, multiple instances of construction engine 122 and query engine 124 could execute on a set of nodes in a distributed and/or cloud computing system to implement the functionality of computing device 100. In another example, construction engine 122 and query engine 124 could execute on various sets of hardware, types of devices, or environments to adapt construction engine 122 or query engine 124 to different use cases or applications. In a third example, construction engine 122 and query engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Construction engine 122 and query engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including construction engine 122 and query engine 124.

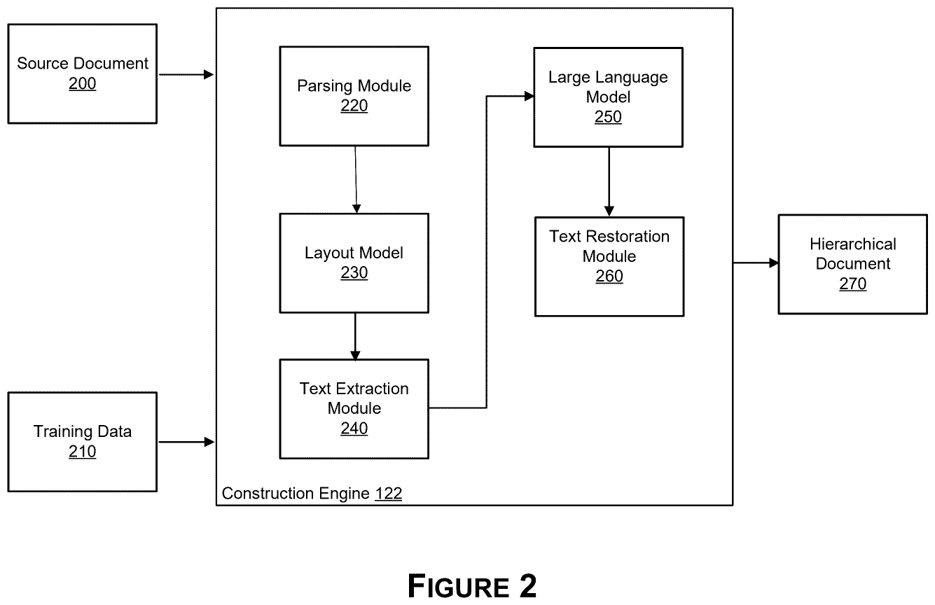

FIG. 2 is a more detailed illustration of construction engine 122 of FIG. 1, according to various embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Construction engine 122 may receive a source document 200 that includes one or more headings, subheadings, or paragraphs. In various embodiments, either or both of headings and subheadings may include hierarchical document elements, such as a document title, a section title, a chapter title, an abstract heading, a bullet point, or an item included in an ordered list. Paragraphs may include one or more of textual content, figures, drawings, images, or tables. A paragraph included in source document 200 may be hierarchically subordinate to at least one heading or subheading included in source document 200. A subheading included in source document 200 may be hierarchically subordinate to at least one other subheading or heading.

Construction engine 122 processes source document 200 and generates, via one or more machine learning models, a hierarchical document 270 that includes the textual content of source document 200 and describes the hierarchical arrangement of headings, subheadings, or paragraphs included in source document 200. Construction engine 122 includes, amongst other elements, parsing module 220, layout model 230, text extraction module 240, large language model 250, and text restoration module 260.

As an overview, construction engine 122 may be configured to convert source document 200 into an image format and parse converted source document 200 to identify text characters included in converted source document 200, along with locations corresponding to the identified text characters. Construction engine 122 may further be configured to generate, via layout model 230, one or more bounding shapes associated with identified text characters included in converted source document 200. Each of the one or more bounding shapes defines a region within converted source document 200 and includes an associated bounding shape type, such as a heading, subheading, or paragraph.

Construction engine 122 extracts identified text characters included in converted source document 200 that are associated with bounding shapes having bounding shape types of heading or subheading, based on a correspondence of locations associated with the identified text characters and the regions defined by the bounding shapes. Construction engine 122 generates a large language model (LLM) prompt based on the extracted text characters and submits a request to large language model 250 to generate a formatted hierarchical representation of the headings and subheadings included in converted source document 200. For example, large language model 250 may generate a JSON-formatted hierarchical listing of headings and subheadings included in converted source document 200. Text restoration module 260 of construction engine 122 may restore paragraph text included in converted source document 200 into the formatted hierarchical listing, inserting paragraph text under the corresponding heading or subheading associated with the paragraph text. In various embodiments, construction engine 122 may fine-tune large language model 250 based on annotated training data 210 to improve the accuracy of large language model 250 when generating a formatted hierarchical listing of headings and subheadings.

In various embodiments, source document 200 may include one or more pages, where each of the one or more pages includes one or more headings, subheadings, or paragraphs. Paragraphs may include textual content, figures, images and/or tables. For example, a paragraph within source document 200 may include a graphical figure having a textual caption.

Source document 200 may be arranged in a hierarchical fashion, where each of one or more subheadings may be subordinate to a heading or to a different subheading, and each of one or more paragraphs may be subordinate to a subheading or heading. In various embodiments, either or both of headings and subheadings may include hierarchical document elements, such as a document title, a section title, a chapter title, an abstract heading, a bullet point, or an item included in an ordered list. Paragraphs may include one or more of textual content, figures, drawings, images, or tables. A paragraph included in source document 200 may be hierarchically subordinate to at least one heading or subheading included in source document 200. A subheading included in source document 200 may be hierarchically subordinate to at least one other subheading or heading. In various embodiments, construction engine 122 may predict the hierarchical arrangement of source document 200 via one or more machine learning models. Construction engine 122 may predict the hierarchical arrangement based on one or more of the relative locations of portions of source document 200, a numbering scheme included in source document 200, varying font types and sizes included in source document 200, or figures or tables included in source document 200.

In embodiments that include parsing module 220, parsing module 220 may convert each page included in source document 200 into an image format for subsequent processing and generate converted source document 200. The image format may include a raster image format, such as a JPEG or GIF format. The image format may also include a Portable Document Format (PDF).

Parsing module 220 may analyze converted source document 200 and extract textual content included in source document 200. Parsing module 220 may execute an optical character recognition (OCR) technique to convert one or more portions of converted source document 200 into text characters. Parsing module 220 may then identify a character location associated with each text character included in converted source document 200, where the character location may include a page number associated with the text character and one or more coordinates associated with the text character. The one or more coordinates may define a location within a page at which the text character is located. Parsing module 220 transmits converted source document 200, the extracted text characters, and the page/location information associated with the extracted text characters to layout model 230.

Layout model 230 includes one or more previously trained machine learning models. The one or more machine learning models are trained to identify one or more portions of converted source document 200 as being headings, subheadings, or paragraphs. In various embodiments, either or both of headings and subheadings may include hierarchical document elements, such as a document title, a section title, a chapter title, an abstract heading, a bullet point, or an item included in an ordered list. Paragraphs may include one or more of textual content, figures, drawings, images, or tables. A paragraph included in source document 200 may be hierarchically subordinate to at least one heading or subheading included in source document 200. A subheading included in source document 200 may be hierarchically subordinate to at least one other subheading or heading. Layout model 230 is further configured to generate a rectangular bounding shape associated with each identified portion of converted source document 200. In various embodiments, layout model 230 may specify a generated bounding shape via a page number associated with an identified portion of converted source document 200 and a pair of coordinates defining opposing corners of the rectangular bounding shape. Layout model 230 generates a label associated with each generated bounding shape, where the label describes the contents of the associated bounding shape—e.g., “heading,” “subheading,” or “paragraph.” Layout model 230 transmits converted source document 200, the generated bounding shapes and bounding shape labels to text extraction module 240.

In various embodiments, construction engine 122 may fine-tune one or more of the trained machine learning models included in layout model 230. Construction engine 122 receives training data 210, where training data 210 includes one or more training documents. Each training document included in training data 210 may include one or more ground truth bounding shapes, where each ground truth bounding shape defines a portion of the training document and includes a ground truth label indicating whether the ground truth bounding shape represents a heading, subheading, or paragraph within the training document. Construction engine 122 may iteratively adjust one or more internal weights included in layout model 230 based on one or more loss functions. A loss function may include a value expressing a difference between a bounding shape or bounding shape label generated by layout model 230 and a corresponding ground truth bounding shape or ground truth label included in training data 210. Construction engine 122 may adjust layout model 230 for a predetermined number of iterations or until one or more of the loss functions are below an associated predetermined threshold.

Text extraction module 240 identifies one or more bounding shapes generated by layout model 230 that include an associated label of “heading” or “subheading.” For each of the identified bounding shapes, text extraction module 240 identifies text characters associated with the bounding shape, based on the coordinates of the bounding shape and the text character locations generated by parsing module 220 as described herein. Text extraction module 240 generates a large language model (LLM) prompt based on the bounding shapes, bounding shape labels, and text characters associated with the bounding shapes. The LLM prompt may include one or more items of textual content associated with one or more heading or subheading bounding shapes, along with locations within source document 200 associated with each of the one or more items of textual content. Construction engine 122 transmits the LLM prompt to large language model 250.

Large language model 250 includes one or more machine learning models that have been previously trained to generate a formatted heading structure for a document based on the LLM prompt received from text extraction module 240. For example, large language model 250 may generate a Javascript object notation (JSON)-formatted heading structure based on the LLM prompt and a request from construction engine 122 to generate the formatted heading structure. The formatted heading structure generated by large language model 250 includes a hierarchical arrangement of headings and subheadings included in source document 200. Large language model 250 only generates a formatted heading structure and does not process paragraph content included in source document 200, including textual paragraph content, figures, or tables. By generating a formatted structure including only hierarchical heading and subheading information and ignoring textual paragraph content, large language model 250 is operable to generate a formatted heading structure for multi-page documents having potentially complex arrangements of headings and subheadings. Large language model 250 transmits the generated formatted heading structure to text restoration module 260.

Text restoration module 260 inserts paragraph content included in source document 200 into the formatted heading structure received from large language model 250 to generate hierarchical document 270 that includes all heading, subheading, and paragraph information associated with source document 200.

For each heading and/or subheading included in the formatted heading structure, text restoration module 260 determines a location within converted source document 200 associated with the heading or subheading, based on the bounding shape coordinates associated with the heading or subheading. Text restoration module 260 identifies one or more bounding shapes generated by layout model 230 and having a label of “paragraph.” For each of the identified paragraph bounding shapes, text restoration module 260 inserts the contents of the paragraph bounding shape into the formatted heading structure based on a location associated with the paragraph bounding shape and locations associated with the headings or subheadings included in the formatted heading structure. For example, text restoration module 260 may determine that within converted source document 200, a paragraph bounding shape appears immediately below a subheading bounding shape based on the relative locations of the paragraph and subheading bounding shapes. Text restoration module 260 may then insert the contents of the paragraph bounding shape into the formatted heading structure immediately below the subheading associated with the subheading bounding shape. Text restoration module continues to insert paragraph content associated with any remaining paragraph bounding shapes into the formatted heading structure until text restoration module 260 has inserted the contents of all paragraph bounding shapes into the formatted heading structure. As described herein, the contents of a paragraph bounding shape may include one or more of textual content, figures, images or tables. Text restoration module 260 generates hierarchical document 270 based on the formatted heading structure and inserted paragraph content.

Hierarchical document 270 includes all of the heading, subheading, and paragraph content of source document 200, organized in the explicit hierarchical arrangement defined by the formatted heading structure generated by large language model 250 and modified with the paragraph content inserted by test restoration module 260. Construction engine 122 transmits hierarchical document 270 to query engine 122. Construction engine 122 may also record hierarchical document in, e.g., storage 114.

Although examples are described herein with respect to using language models, and specifically large language models the large language model 250, this is not intended to be limiting. For example, and without limitation, large language model 250 described herein may include one or more of any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

Additionally, construction engine 122 is one example of an engine which may be used in at least one embodiment, such as for executing an MLM for use in language processing to generate a hierarchical document, or for other purposes. However, construction engine 122 may be varied to include more, fewer, and/or different components and/or processing paths than what is shown in FIG. 2.

Construction engine 122 may be implemented in a cloud computing environment and made available to one or more customers or clients as a construction microservice for source documents. In various embodiments where monitoring engine is executed as a construction microservice, each of one or more instances of large language model 250 may be trained or fine-tuned based on a different client's source documents. In other embodiments, one or more instances of large language model may be trained or fine-tuned on the same source documents.

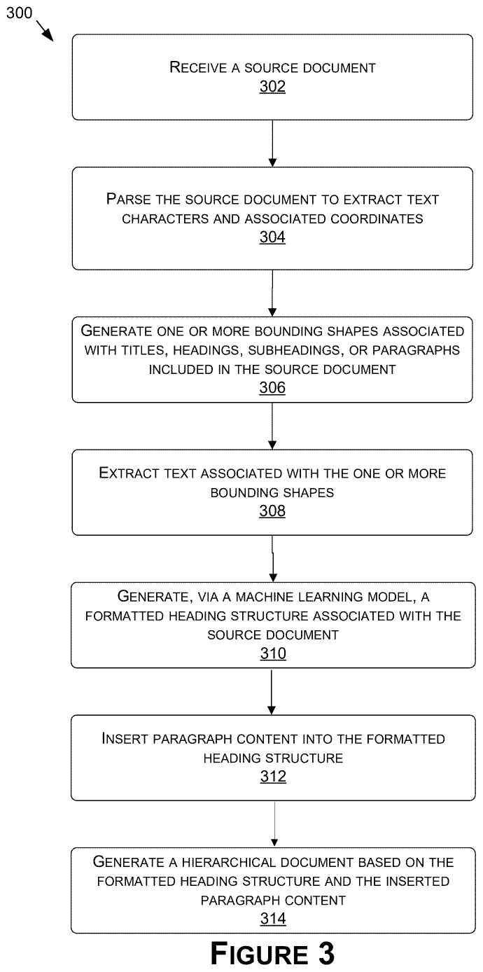

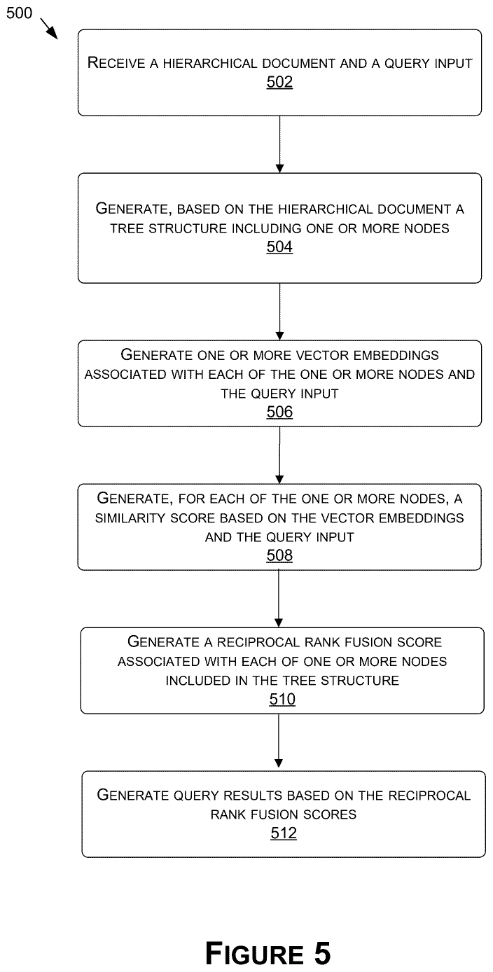

Now referring to FIGS. 3 and 5, each operation of methods 300 and 500, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 300 and 500 is/are described, by way of example, with respect to the systems of FIGS. 1-2 and 4. However, these methods may additionally or alternatively be executed by any one system, or any combination of systems, including, but not limited to, those described herein.

FIG. 3 illustrates a flow diagram of a method for generating a hierarchical representation of a source document, according to various embodiments. As shown in FIG. 3, method 300 begins with operation 302, in which construction engine 122 receives source document 200. In various embodiments, source document 200 includes, but is not limited to, one or more headings, subheadings, or paragraphs, where each the one or more paragraphs may include one or more of textual content, figures, or tables.

The method 300, at operation 304, includes parsing source document 200, via parsing module 220, to identify text characters included in source document 200 and locations associated with the identified text characters. In some embodiments, parsing module 220 may convert each page included in source document 200 into an image format, such as a JPEG, GIF, or PDF format. For each image format page included in source document 200, parsing module 220 performs an optical character recognition (OCR) technique suitable to identify text characters in the image. For each identified text character, parsing module 220 also generates a location within document 200 associated with the text character. In various embodiments, the location may include a page number within source document 200, coordinates defining a relative position of the text character within the page, or a combination thereof.

The method 300, at operation 306, includes generating, via trained layout model 230, one or more bounding shapes associated with source document 200. Each bounding shape includes an associated page number and coordinates defining a position of the bounding shape within the page. For example, trained layout model 230 may generate coordinates defining two opposing corners of a rectangular bounding shape. Layout model 230 further generates a label associated with each bounding shape, where the label describes the bounding shape as representing heading content, subheading content, or paragraph content.

The method 300, at operation 308, includes extracting text associated with one or more of the bounding shapes generated by layout model 230. In various embodiments, text extraction module 240 identifies text associated with bounding shapes labeled as headings or subheadings. Text extraction module 240 aggregates the identified text into a large language model (LLM) prompt.

The method 300, at operation 310, includes generating, via large language model 250, a formatted heading structure associated with source document 200 and based on the LLM prompt generated by text extraction module 240. Construction engine 122 may transmit the LLM prompt to large language model 250, along with a textual request for large language model 250 to generate a formatted heading structure based on the LLM prompt. For example, construction engine 122 may request that large language model 250 generate a JSON-formatted heading structure based on the provided LLM prompt.

The method 300, at operation 312, includes inserting paragraph content into the formatted heading structure generated by large language model 250. For each bounding shape generated by layout model 230 and having an associated label indicating that the bounding shape is associated with paragraph content, text restoration module 260 may insert the paragraph content into the formatted heading structure based on location coordinates associated with the paragraph bounding shape and location coordinates associated with a heading or subheading bounding shape generated by layout model 230. Based on the location coordinates, text restoration module 260 inserts the paragraph content into the formatted heading structure immediately below the heading or subheading to which the paragraph content is subordinate. Paragraph content may include one or more of textual content, a figure, or a table.

The method 300, at operation 314, generates hierarchical document 270 based on the formatted heading structure and the inserted paragraph content. Hierarchical document 270 includes all of the content included in source document 200. Hierarchical document 270 also includes the explicit hierarchical relationship between headings, subheadings, and paragraphs defined by the formatted heading structure and inserted paragraph content. Construction engine 122 may transmit hierarchical document 270 to query engine 124. Additionally or alternatively, construction engine 122 may store hierarchical document 270 in, e.g., storage 114.

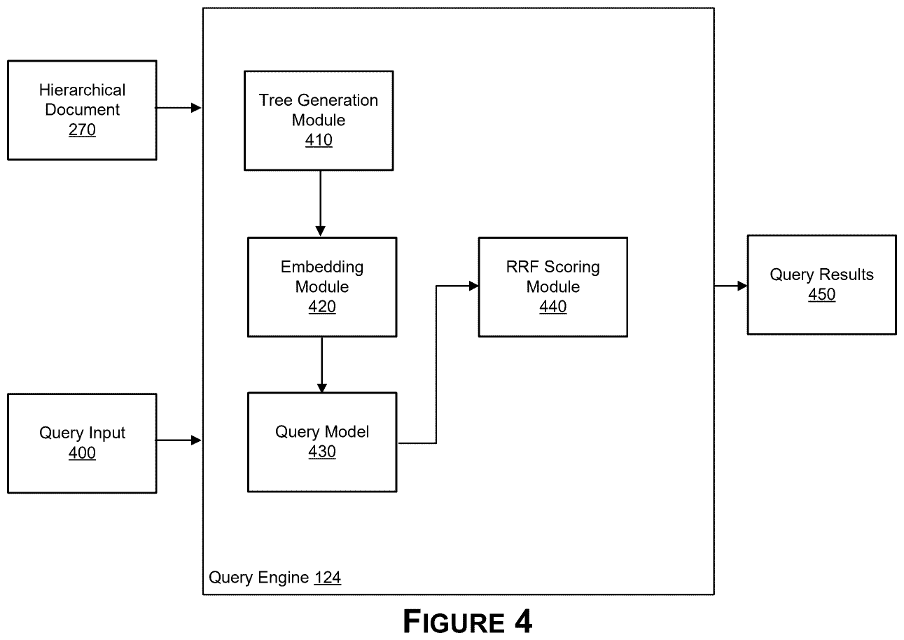

FIG. 4 is a more detailed illustration of query engine 124 of FIG. 1, according to various embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As an overview, query engine 124 may receive hierarchical document 270 from construction engine 122 and a query input 400 and generate query results 450. Query engine 124 generates one or more nodes and edges representing the hierarchical arrangement of headings, subheadings, and paragraphs included in hierarchical document 270. Query engine 124 traverses the generated nodes and edges, and, for each of the one or more nodes, query engine 124 generates one or more vector embeddings s based on textual content associated with the node. Query engine 124 generates, via a query model, a similarity score associated with each of the one or more nodes based on the vector embeddings associated with the node and the contents of query input 400. For each of the one or more nodes associated with a paragraph included in hierarchical document 270, query engine 124 calculates a reciprocal rank fusion (RRF) score based on the similar score associated with the paragraph node and the similarity scores associated with one or more nodes having a parent relationship to the paragraph node. Query engine 124 generates query results 450, where query results 450 include paragraph content associated with the paragraph node having the highest calculated RRF score.

Query engine 124 receives hierarchical document 270 from construction engine 122. Alternatively, query engine 124 may receive a previously generated hierarchical document 270 stored in, e.g., storage 114. As described herein, hierarchical document 270 includes a formatted representation of a hierarchical arrangement of headings, subheadings, and paragraphs included in a source document. Hierarchical document 270 also includes textual content associated with each of the headings or subheadings. Hierarchical document 270 further includes paragraph content associated with each paragraph included in hierarchical document 270, where the paragraph content may include textual content, a figure, and/or a table.

Query engine 124 receives query input 400, where query input 400 may include one or more search terms. In various embodiments, each of the one or more search terms may include textual content, image content, or any other content expressed in a suitable modality.

In embodiments that include node generation module 410, query engine 124 may generate, via node generation module 410 and based on hierarchical document 270, a tree structure including nodes and edges that represents the hierarchical structure of hierarchical document 270.

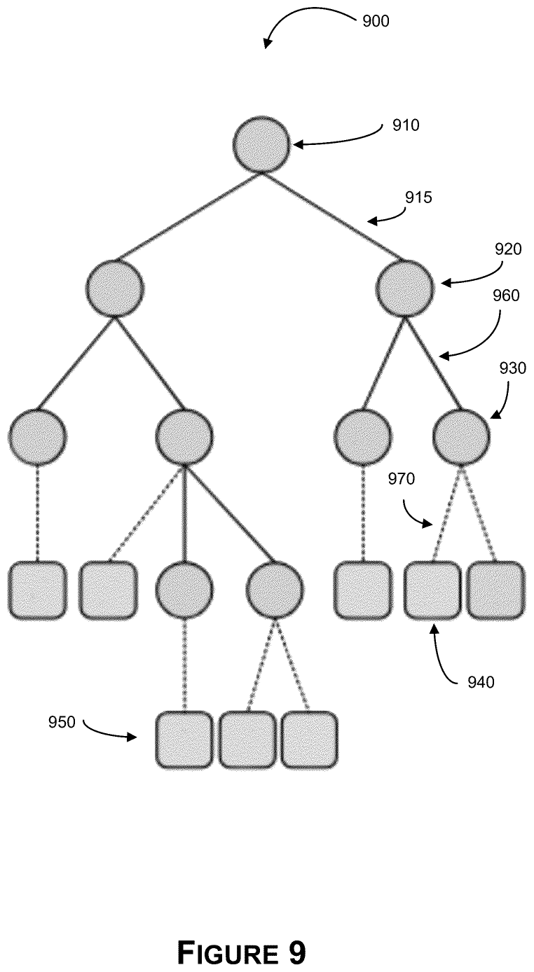

Turning to FIG. 9, FIG. 9 is an example tree structure 900 associated with a hierarchical document 270, according to at least some embodiments of the present disclosure. Node generation module 410 processes hierarchical document 270 and generates tree structure 900 based on the hierarchical relationships defined by hierarchical document 270.

As shown in FIG. 9, tree structure 900 includes one or more nodes represented by shaded circles, such as nodes 910, 920, and 930. Nodes represented by shaded circles are associated with headings or subheadings included in hierarchical document 270. Tree structure 900 also includes one or more nodes represented by shaded squares, such as nodes 940 and 950. Nodes represented by shaded squares represent paragraphs included in hierarchical document 270. Paragraphs included in hierarchical document 270 may include textual content, figures, or tables.

Tree structure 900 further includes one or more edges represented by solid or dashed lines. An edge represented by a solid line, such as edge 960, represents a hierarchical relationship between two nodes, where each node represents a heading or subheading. An edge represented by a dashed line, such as edge 970, represents a hierarchical relationship between a node representing a heading or subheading and a node representing a paragraph that appears immediately below the heading or subheading in hierarchical document 270.

Tree structure 900 describes parent-child relationships between various pairs of nodes. Tree structure 900 includes a root node, such as node 910, which includes one or more edges extending downward from the root node to one or more different nodes, and no edges extending upward from the root node. A first node is a parent of a second node if there exists one or more edges that form a downward path within tree structure 900 from the first node to the second node. The downward path may include one or more intermediate nodes located between the first node and the second node in tree structure 900. For example, nodes 910, 920, and 930 are all parents of node 940, as there exists a downward path from node 910 to node 940 including edge 915, node 920, edge 960, node 930, and edge 970. As a consequence, a root node, such as node 910, is a parent node to every other node included in tree structure 900, as there exists a downward path from node 910 to every other node included in tree structure 900. Similarly, every node in tree structure 900 other than root node 910 may be described as having an associated root path that includes an ordered list of nodes and/or edges that form a path from the node to root node 910. As an example, paragraph node 940 includes a root path having an ordered list including edge 970, node 930, edge 960, node 920, edge 915, and root node 910. In various embodiments, each of the paragraph nodes, such as nodes 950 and 960, will always be immediately subordinate to exactly one heading or subheading node. Further, a paragraph node will not be a parent to any other node included in tree structure 900.

Returning to FIG. 4, node generation module 410 generates tree structure 900 based on hierarchical document 270. Node generation module 410 creates a node associated with each heading, subheading, and paragraph included in hierarchical document 270. Node generation module 410 further generates one or more edges connecting nodes as defined by hierarchical document 270. Node generation module transmits tree structure 900 to embedding module 420.

For each node included in tree structure 900, embedding module 420 generates one or more vector embeddings associated with the node. Each of the one or more vector embeddings may encode, as a vector, semantic information included in a heading, subheading, or paragraph associated with the node. In various embodiments, embedding module 420 may include any embedding technique suitable to generate vector embeddings based on semantic information included in textual content, image content, or other modalities of content.

Embedding module 420 may also generate vector embeddings based on semantic content included in the one or more search terms included in query input 400 described herein. Embedding module 420 transmits tree structure 900, the vector embeddings associated with each node included in tree structure 900, and the vector embeddings associated with query input 400 to query model 430.

Query model 430 generates a similarity score associated with each of one or more nodes included in tree structure 900 received from embedding module 420. In various embodiments, a similarity score associated with a particular node is based on a comparison between vector embeddings associated with the contents of the node and vector embeddings associated with one or more search terms included in query input 400. In various embodiments, query module 430 may generate similarity scores associated with the one or more nodes sequentially or simultaneously. In some embodiments, query module 430 may simultaneously generate similarity scores associated with multiple nodes via multithreading or multitasking techniques. Other embodiments may include multiple instances of query module 430, where each instance of query module 430 simultaneously generates similarity scores associated with multiple nodes. Query model 430 transmits the similarity scores associated with each node included in tree structure 900 to RRF scoring module 440.

Reciprocal Rank Fusion (RRF) scoring module 440 generates a fusion score for each paragraph node included in tree structure 900 associated with hierarchical document 270. The fusion score is based on a weighted combination of a paragraph node's similarity score and the similarity scores of one or more nodes having a parent relationship to the paragraph node. By generating a weighted combination of scores associated with the paragraph node and the one or more parent nodes, RRF scoring module 440 captures not only relevant semantic information included in the paragraph node, but also relevant semantic information included in the one or more parent heading or subheading nodes.

The reciprocal rank fusion score associated with a paragraph node d included in tree structure 900 is given by:

$$RRF score ( d ∈ D ) = {Σ}_{r ∈ R} \frac{1}{k + r ( d )} \qquad ( 1 )$$

Where d is one of all nodes D included in tree structure 900, k represents a constant value, e.g. 60 in some embodiments, and Σ_{r∈R} represents a summation of the term

$$\frac{1}{k + r ( d )}$$

over one or more nodes r included in the root path R of node d. For example, given tree structure 900 discussed herein, RRF fusion module 440 may generate a fusion score for paragraph node 940. The root path R for paragraph node 940 includes node 940 itself and parent nodes 930, 920, and 910. RRF module 440 evaluates Equation (1) over the set of nodes 940, 930, 920, and 910 to generate a fusion score for node 940. In various embodiments, RRF score module 440 may evaluate a fusion score for each paragraph node included in tree structure 900. In other embodiments, RRF scoring module 440 may evaluate a fusion score for all nodes included in tree structure 900, including heading, subheading, and paragraph nodes.

RRF scoring module 440 identifies the paragraph node having the highest calculated fusion score and transmits an identifier associated with the highest-scoring paragraph node to query engine 124. Query engine 124 generates query results 450 based on the identified highest-scoring paragraph node and the contents of the highest-scoring paragraph node as included in hierarchical document 270.

Query results 450 include the contents of the paragraph node having the highest reciprocal rank fusion score as calculated by RRF scoring module 440. Query engine 124 retrieves the paragraph content included in hierarchical document 270 associated with the highest-scoring paragraph node included in tree structure 900. As discussed herein, the retrieved paragraph content may include one or more of textual content, figure content, or table content. Query engine 124 may present query results 450 via one or more of I/O devices 108. Additionally or alternatively, query engine 124 may store query results 450 in, e.g., storage 114.

FIG. 5 illustrates a flow diagram of a method for querying a hierarchical representation of a source document, according to various embodiments. As shown in FIG. 5, method 500 begins with operation 502, in which the query engine 124 receives hierarchical document 270 and query input 400. Hierarchical document 270 includes all of the heading, subheading, and paragraph content of source document 200, organized in the explicit hierarchical arrangement defined by the formatted heading structure generated by large language model 250. Query input 400 may include one or more search terms. In various embodiments, each of the one or more search terms may include textual content, image content, or any other content expressed in a suitable modality.

The method 500, at operation 504, includes generating a tree structure 900 based on hierarchical document 270, where the tree structure includes one or more nodes and one or more edges. Tree structure 900 describes parent-child relationships between various pairs of nodes. Tree structure 900 includes a root node, such as node 910, which includes one or more edges extending downward from the root node to one or more different nodes, and no edges extending upward from the root node. A first node is a parent of a second node if there exists one or more edges that form a downward path within tree structure 900 from the first node to the second node. The downward path may include one or more intermediate nodes located between the first node and the second node in tree structure 900. For example, nodes 910, 920, and 930 are all parents of node 940, as there exists a downward path from node 910 to node 940 including edge 915, node 920, edge 960, node 930, and edge 970. As a consequence, a root node, such as node 910, is a parent node to every other node included in tree structure 900, as there exists a downward path from node 910 to every other node included in tree structure 900. Similarly, every node in tree structure 900 other than root node 910 may be described as having an associated root path that includes an ordered list of nodes and/or edges that form a path from the node to root node 910. As an example, paragraph node 940 includes a root path having an ordered list including edge 970, node 930, edge 960, node 920, edge 915, and root node 910. In various embodiments, each of the paragraph nodes, such as nodes 950 and 960, will always be immediately subordinate to exactly one heading or subheading node. Further, a paragraph node will not be a parent to any other node included in tree structure 900.

The method 500, at operation 506, includes generating one or more vector embeddings associated with each of the one or more nodes included in tree structure 900. Each of the one or more vector embeddings may encode, as a vector, semantic information included in a heading, subheading, or paragraph associated with the node. In various embodiments, embedding module 420 may include any embedding technique suitable to generate vector embeddings based on semantic information included in textual content, image content, or other modalities of content.

Embedding module 420 may also generate vector embeddings based on semantic content included in the one or more search terms included in query input 400 described herein. Embedding module 420 transmits tree structure 900, the vector embeddings associated with each node included in tree structure 900, and the vector embeddings associated with query input 400 to query model 430.

The method 500, at operation 508, includes generating, via query model 430, a similarity score associated with each of the one or more nodes included in tree structure 900. In various embodiments, a similarity score associated with a particular node is based on a comparison between vector embeddings associated with the contents of the node and vector embeddings associated with one or more search terms included in query input 400. In various embodiments, Query module 430 may generate similarity scores associated with the one or more nodes sequentially or simultaneously. In some embodiments, query module 430 may simultaneously generate similarity scores associated with multiple nodes via multithreading or multitasking techniques. Other embodiments may include multiple instances of query module 430, where each instance of query module 430 simultaneously generates similarity scores associated with multiple nodes. Query model 430 transmits the similarity scores associated with each node included in tree structure 900 to RRF scoring module 440.

The method 500, at operation 510, includes generating a reciprocal rank fusion score associated with each of the one or more nodes included in tree structure 900. Reciprocal Rank Fusion (RRF) scoring module 440 generates a fusion score for each paragraph node included in tree structure 900 associated with hierarchical document 270. The fusion score is based on a weighted combination of a paragraph node's similarity score and the similarity scores of one or more nodes having a parent relationship to the paragraph node. By generating a weighted combination of scores associated with the paragraph node and the one or more parent nodes, RRF scoring module 440 captures not only relevant semantic information included in the paragraph node, but also relevant semantic information included in the one or more parent heading and subheading nodes. For example, given tree structure 900 discussed herein, RRF fusion module 440 may generate a fusion score for paragraph node 940 based on similarity scores associated with paragraph node 940 and one or more nodes included in a root path associated with paragraph node 940. The root path R for paragraph node 940 includes node 940 itself and parent nodes 930, 920, and 910. RRF module 440 evaluates a weighted combination of similarity scores over the set of nodes 940, 930, 920, and 910 to generate a fusion score for node 940. RRF module 440 evaluates a fusion score for each paragraph node included in tree structure 900. RRF scoring module 440 identifies the paragraph node having the highest calculated fusion score and transmits an identifier associated with the highest-scoring paragraph node to query engine 124.

The method 500, at operation 512, includes generating query results 450 based on the paragraph node having the highest reciprocal rank fusion score. Query results 450 include the contents of the paragraph node having the highest reciprocal rank fusion score as calculated by RRF scoring module 440. Query engine 124 retrieves the paragraph content included in hierarchical document 270 associated with the highest-scoring paragraph node included in tree structure 900. As discussed herein, the retrieved paragraph content may include one or more of textual content, figure content, or table content. Query engine 124 may present query results 450 via one or more of I/O devices 108. Additionally or alternatively, query engine 124 may store query results 450 in, e.g., storage 114.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some embodiments, the systems and methods described herein may be performed within a simulation environment (e.g., NVIDIA's DriveSIM, NVIDIA's ISAAC GYM, NVIDIA's ISAAC SIM, etc.) using simulated data (e.g., simulated sensor data of simulated sensors of a virtual or simulated machine). For example, simulated sensor data may be used (e.g., processed using one or more machine learning models, neural networks, etc.) to identify, detect, and/or classify lane lines, obstacles, navigation paths, road boundary lines, other lines, vertical structures/features, etc. within the simulation environment using points of a curve and/or one or more curve fitting algorithms, and may use this information to perform operations (e.g., control, navigation, obstacle avoidance, planning, etc. operations) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. In some embodiments, other methods may be used in addition or alternatively from a simulation to generate synthetic training data. For example, the synthetic training data may be generated using neural rendering fields (NERFs), Gaussian splat techniques, diffusion models, electrostatic models (e.g., Poisson flow generative models (PFGMs), etc. The synthetic training data (in addition to or alternatively from real-world data) may then be processed to determine geometry, curvature, semantic information, classification information, and/or other information related to features of interest, such as lines, obstacles, paths, longitudinal features (e.g., poles), and/or other features within a driving environment, a warehouse, etc., for example. In any example, such as where a simulation environment is used for testing, validation, training, etc., the simulation environment and/or associated training data may be rendered or otherwise generated using one or more light transport algorithms-such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system that uses universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems-such as systems for testing, validating, training (e.g., machine learning models, neural networks, etc.), and/or other tasks related to automotive, robot, machine, or other applications.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs-such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, one or more transformer engines (TEs) may be implemented. The transformer engine may use micro-tensor scaling to optimize performance and accuracy-such as to enable 16-bit floating point (FP16), 8-bit floting point (FP8), and/or 4-bit floating point (FP4) artificial intelligence processing. For example, the transformer engine may use 16-bit or 8-bit floating point precision and an 8-bit or 4-bit floating point data format combined with software algorithms for furing increasing AI performance and capabilities. By reducing math operations to 8-bits or 4-bits, the TE allows for training larger networks faster without compromising accuracy. For example, the TEs may include a library for accelerating transformer models on processing devices-such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716 (N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundational models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundational model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant-such as in a case where specific knowledge is required. The RAG component 892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve-using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents-which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features-such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using-plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources-such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer810 of FIG. 8A) into tokens such as words, and each token is encoded (e.g., by the embedding component 820 of FIG. 8A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.
1. In some embodiments, a computer-implemented method comprises generating, using a first machine learning model, a hierarchical structure associated with a source document, the hierarchical structure including one or more headings and one or more paragraphs, identifying, using the first machine learning model, heading text included in the source document and associated with individual of the one or more headings and paragraph text included in the source document and associated with individual of the one or more paragraphs, generating, using a second machine learning model and based at least on the identified heading text included in the source document, a formatted listing including the heading text associated with individual of the one or more headings, generating a hierarchical document based at least on the formatted listing and the paragraph text associated with the one or more paragraphs, and performing a query on the source document based at least on the hierarchical document.
2. The computer-implemented method of clause 1, wherein individual of the one or more headings includes a document title, a section title, a chapter title, an abstract heading, a bullet point, or an item included in an ordered list.
3. The computer-implemented method of clauses 1 or 2, wherein individual of the one or more paragraphs includes textual content, a figure, a drawing, an image, or a table.
4. The computer-implemented method of any of clauses 1-3, wherein the identifying the heading text included in the source document further comprises generating one or more bounding shapes associated with headings included in the source document.
5. The computer-implemented method of any of clauses 1-4, wherein the generating the hierarchical document further comprises inserting the paragraph text into the formatted listing at a position based at least on the heading text included in the formatted listing.
6. The computer-implemented method of any of clauses 1-5, further comprising converting one or more pages included in the source document into an image format.
7. The computer-implemented method of any of clauses 1-6, wherein the second machine learning model includes a large language model (LLM).
8. The computer-implemented method of any of clauses 1-7, wherein the source document includes a plurality of individual pages.
9. The computer-implemented method of any of clauses 1-8, wherein the method is performed by at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multi-model language models, a system implementing one or more large language models (LLMs), a system implementing one or more vision language models (VLMs), a system for generating synthetic data, a system for generating synthetic data using AI, a system incorporating one or more virtual machines (VMs), a system implemented at least partially in a data center, or a system implemented at least partially using cloud computing resources.
10. In some embodiments, one or more processors comprising processing circuitry to generate, via a first machine learning model, a hierarchical structure associated with a source document, wherein the hierarchical structure includes one or more headings and one or more paragraphs, identify, via the first machine learning model, heading text included in the source document and associated with each of the one or more headings and paragraph text included in the source document and associated with each of the one or more paragraphs, generate, via a second machine learning model and based at least on the identified heading text included in the source document, a formatted listing including the heading text associated with each of the one or more headings, generate a hierarchical document based at least on the formatted listing and the paragraph text associated with the one or more paragraphs, and store the hierarchical document in connection with the source document to aid in performance of one or more queries of the source document.
11. The one or more processors of clause 10, wherein each of the one or more headings includes a document title, a section title, a chapter title, an abstract heading, a bullet point, or an item included in an ordered list.
12. The one or more processors of clauses 10 or 11, wherein each of the one or more paragraphs includes textual content, a figure, a drawing, an image, or a table.
13. The one or more processors of any of clauses 10-12, wherein the identifying the heading text included in the source document further comprises generating one or more bounding shapes associated with headings included in the source document.
14. The one or more processors of any of clauses 10-13, wherein the generating the hierarchical document further comprises inserting the paragraph text into the formatted listing at a position based at least on the heading text included in the formatted listing.
15. The one or more processors of any of clauses 10-14, further comprising converting one or more pages included in the source document into an image format.
16. The one or more processors of any of clauses 10-15, wherein the source document includes a plurality of individual pages.
17. The one or more processors of any of clauses 10-16, wherein the one or more processors are comprised in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multi-model language models, a system implementing one or more large language models (LLMs), a system implementing one or more vision language models (VLMs), a system for generating synthetic data, a system for generating synthetic data using AI, a system incorporating one or more virtual machines (VMs), a system implemented at least partially in a data center, or a system implemented at least partially using cloud computing resources.
18. In some embodiments, a system comprises one or more processors to perform a search with respect to a source document using a hierarchical document associated with the source document, the hierarchical document generated based at least on a first machine learning model generating heading text associated with sub-sections of the source document and a second machine learning model generating a formatted listing of the heading text.
19. The system of clause 18, wherein the sub-sections include a title, a section title, a chapter title, an abstract heading, a bullet point, or an item included in an ordered list.
20. The system of clauses 18 or 19, wherein the system is comprised in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multi-model language models, a system implementing one or more large language models (LLMs), a system implementing one or more vision language models (VLMs), a system for generating synthetic data, a system for generating synthetic data using AI, a system incorporating one or more virtual machines (VMs), a system implemented at least partially in a data center, or a system implemented at least partially using cloud computing resources.
21 In some embodiments, a computer-implemented method comprises receiving a hierarchical document tree including one or more parent and child nodes each associated with a portion of a source document, generating, using a machine learning model and based at least on a query prompt and contents of each of the one or more parent and child nodes, a similarity score for each of the one or more parent and child nodes, calculating combined similarity scores associated with each of one or more child nodes based at least on the similarity score associated with the child node and one or more similarity scores associated with one or more nodes having a parent relationship to the child node, and generating a query result based at least on the combined similarity scores associated with the one or more child nodes.
22. The computer-implemented method of clause 21, wherein each of the one or more parent nodes is associated with a heading or subheading included in the source document.
23. The computer-implemented method of clauses 21 or 22, wherein each of the one or more child nodes is associated a paragraph included in the source document.
24 The computer-implemented method of any of clauses 21-23, wherein the combined similarity score is based at least on a weighted combination of the similarity score associated with the child node and the one or more similarity scores associated with the one or more nodes having a parent relationship to the child node.
25 The computer-implemented method of any of clauses 21-24, wherein the query result includes the contents of a paragraph included in the source document.
26. The computer-implemented method of any of clauses 21-25, further comprising generating one or more vector embeddings associated with each of the one or more parent nodes and generating one or more vector embeddings associated with each of the one or more child nodes.
27. The computer-implemented method of any of clauses 21-26, further comprising generating one or more vector embeddings associated with one or more search terms included in the query prompt.
28 The computer-implemented method of any of clauses 21-27, wherein the similarity score associated with a parent node or a child node is based at least on a comparison between first vector embeddings associated with the contents of the parent node or child node and second vector embeddings associated with one or more search terms included in the query prompt.
29. The computer-implemented method of any of clauses 21-28, wherein the method is performed by at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multi-model language models, a system implementing one or more large language models (LLMs), a system implementing one or more vision language models (VLMs), a system for generating synthetic data, a system for generating synthetic data using AI, a system incorporating one or more virtual machines (VMs), a system implemented at least partially in a data center, or a system implemented at least partially using cloud computing resources.
30 In some embodiments, one or more processors comprising processing circuitry to receive a hierarchical document tree including one or more parent and child nodes, where each of the one or more parent and child nodes is associated with a portion of a source document, generate, via a machine learning model, a similarity score for each of one or more parent and child nodes, based at least on a query prompt and the contents of the parent or child node, calculate combined similarity scores associated with each of one or more child nodes, based at least on the similarity score associated with the child node and one or more similarity scores associated with one or more nodes having a parent relationship to the child node, and generate a query result based at least on the combined similarity scores associated with the one or more child nodes.
31 The one or more processors of clause 30, wherein each of the one or more parent nodes is associated with a heading or subheading included in the source document.
32. The one or more processors of clauses 30 or 31, wherein each of the one or more child nodes is associated a paragraph included in the source document.
33. The one or more processors of any of clauses 30-32, wherein the combined similarity score is based at least on a weighted combination of the similarity score associated with the child node and the one or more similarity scores associated with the one or more nodes having a parent relationship to the child node.
34 The one or more processors of any of clauses 30-33, wherein the processing circuitry further generates one or more vector embeddings associated with each of the one or more parent nodes and generates one or more vector embeddings associated with each of the one or more child nodes.
35 The one or more processors of any of clauses 30-34, wherein the processing circuitry further generates one or more vector embeddings associated with one or more search terms included in the query prompt.
36 The one or more processors of any of clauses 30-35, wherein the similarity score associated with a parent node or a child node is based at least on a comparison between first vector embeddings associated with the contents of the parent node or child node and second vector embeddings associated with one or more search terms included in the query prompt.
37 The one or more processors of any of clauses 30-36, wherein the one or more processors are comprised in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multi-model language models, a system implementing one or more large language models (LLMs), a system implementing one or more vision language models (VLMs), a system for generating synthetic data, a system for generating synthetic data using AI, a system incorporating one or more virtual machines (VMs), a system implemented at least partially in a data center, or a system implemented at least partially using cloud computing resources.
38. In some embodiments, a system comprises one or more processors to execute operations comprising receiving a hierarchical document tree including one or more parent and child nodes, where each of the one or more parent and child nodes is associated with a portion of a source document, generating, via a machine learning model, a similarity score for each of one or more parent and child nodes, based at least on a query prompt and the contents of the parent or child node, calculating combined similarity scores associated with each of one or more child nodes, based at least on the similarity score associated with the child node and one or more similarity scores associated with one or more nodes having a parent relationship to the child node, and generating a query result based at least on the combined similarity scores associated with the one or more child nodes.
39. The system of clause 38, wherein the combined similarity score is based at least on a weighted combination of the similarity score associated with the child node and the one or more similarity scores associated with the one or more nodes having a parent relationship to the child node.
40. The system of clauses 38 or 39, wherein the system is comprised in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multi-model language models, a system implementing one or more large language models (LLMs), a system implementing one or more vision language models (VLMs), a system for generating synthetic data, a system for generating synthetic data using AI, a system incorporating one or more virtual machines (VMs), a system implemented at least partially in a data center, or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step,” “operation,” and/or “block” may be used herein to connote different elements of methods employed, the terms should not be interpreted as implying any particular order among or between various steps herein disclosed unless and except when the order of individual steps is explicitly described.

What is claimed is:

1. A computer-implemented method comprising:
receiving a hierarchical document tree including one or more parent and child nodes each associated with a portion of a source document;
generating, using a machine learning model and based at least on a query prompt and contents of each of the one or more parent and child nodes, a similarity score for each of the one or more parent and child nodes;
calculating combined similarity scores associated with each of one or more child nodes based at least on the similarity score associated with the child node and one or more similarity scores associated with one or more nodes having a parent relationship to the child node; and
generating a query result based at least on the combined similarity scores associated with the one or more child nodes.

2. The computer-implemented method of claim 1, wherein each of the one or more parent nodes is associated with a heading or subheading included in the source document.

3. The computer-implemented method of claim 1, wherein each of the one or more child nodes is associated a paragraph included in the source document.

4. The computer-implemented method of claim 1, wherein the combined similarity score is based at least on a weighted combination of the similarity score associated with the child node and the one or more similarity scores associated with the one or more nodes having a parent relationship to the child node.

5. The computer-implemented method of claim 1, wherein the query result includes the contents of a paragraph included in the source document.

6. The computer-implemented method of claim 1, further comprising generating one or more vector embeddings associated with each of the one or more parent nodes and generating one or more vector embeddings associated with each of the one or more child nodes.

7. The computer-implemented method of claim 1, further comprising generating one or more vector embeddings associated with one or more search terms included in the query prompt.

8. The computer-implemented method of claim 1, wherein the similarity score associated with a parent node or a child node is based at least on a comparison between first vector embeddings associated with the contents of the parent node or child node and second vector embeddings associated with one or more search terms included in the query prompt.

9. The computer-implemented method of claim 1, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

10. One or more processors comprising processing circuitry to:
receive a hierarchical document tree including one or more parent and child nodes, where each of the one or more parent and child nodes is associated with a portion of a source document;
generate, via a machine learning model, a similarity score for each of one or more parent and child nodes, based at least on a query prompt and the contents of the parent or child node;
calculate combined similarity scores associated with each of one or more child nodes, based at least on the similarity score associated with the child node and one or more similarity scores associated with one or more nodes having a parent relationship to the child node; and
generate a query result based at least on the combined similarity scores associated with the one or more child nodes.

11. The one or more processors of claim 10, wherein each of the one or more parent nodes is associated with a heading or subheading included in the source document.

12. The one or more processors of claim 10, wherein each of the one or more child nodes is associated a paragraph included in the source document.

13. The one or more processors of claim 10, wherein the combined similarity score is based at least on a weighted combination of the similarity score associated with the child node and the one or more similarity scores associated with the one or more nodes having a parent relationship to the child node.

14. The one or more processors of claim 10, wherein the processing circuitry further generates one or more vector embeddings associated with each of the one or more parent nodes and generates one or more vector embeddings associated with each of the one or more child nodes.

15. The one or more processors of claim 10, wherein the processing circuitry further generates one or more vector embeddings associated with one or more search terms included in the query prompt.

16. The one or more processors of claim 10, wherein the similarity score associated with a parent node or a child node is based at least on a comparison between first vector embeddings associated with the contents of the parent node or child node and second vector embeddings associated with one or more search terms included in the query prompt.

17. The one or more processors of claim 10, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

18. A system comprising:
one or more processors to execute operations comprising:
receiving a hierarchical document tree including one or more parent and child nodes, where each of the one or more parent and child nodes is associated with a portion of a source document;
generating, via a machine learning model, a similarity score for each of one or more parent and child nodes, based at least on a query prompt and the contents of the parent or child node;
calculating combined similarity scores associated with each of one or more child nodes, based at least on the similarity score associated with the child node and one or more similarity scores associated with one or more nodes having a parent relationship to the child node; and
generating a query result based at least on the combined similarity scores associated with the one or more child nodes.

19. The system of claim 18, wherein the combined similarity score is based at least on a weighted combination of the similarity score associated with the child node and the one or more similarity scores associated with the one or more nodes having a parent relationship to the child node.

20. The system of claim 18, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
